(19) United States
(12) Patent Application Publication
(10) Pub. No.: US 2003/0204391 A1
(43) Pub. Date: Oct. 30, 2003

(54) Method and system for interpreting information communicated in disparate dialects

(75) Inventors: James A. May, Austin, TX (US); Jaime L. Budet, Austin, TX (US); John D. Dinsmore, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: Isochron Data Corporation

(21) Appl. No.: 10/426,840

(22) Filed: Apr. 30, 2003

Related U.S. Application Data
(60) Provisional application No. 60/376,590, filed on Apr. 30, 2002.

(51) Int. Cl. G06F 17/20

(52) U.S. Cl. 704/8

(57) ABSTRACT

A method and system is provided for the interpretation of information communicated in disparate dialects. The method and system includes a general parser receiving audit reports having data in multiple dialects including unknown dialects. An interpretation module extracts the data from the audit reports and interprets the data while a validation module analyzes the results of the interpretation. For unknown dialects, the general parser either marks an audit report as having an unknown dialect or invokes the learning module which acquires the unknown dialect. The learning module creates a provisional interpretation module and a provisional validation module for the unknown dialect using the data in the unknown dialect audit report. The learning module tests the provisional interpretation module and provisional validation module with additional audit reports having the same dialect as the audit report used to create them and with successful testing are assumed to be correct.

### CROSS REFERENCE TO RELATED APPLICATION

This application claims priority to U.S. Provisional Patent Application Serial No. 60/376,590, filed Apr. 30, 2002, and entitled “METHOD AND SYSTEM FOR INTERPRETING INFORMATION COMMUNICATED IN DISPARATE DIALECTS.”

This application is related to Provisional Patent Application Serial No. 60/203,682, filed May 12, 2000, and entitled “METHOD AND SYSTEM FOR THE OPTIMAL FORMATTING, REDUCTION AND COMPRESSION OF DEX/UCS DATA”, now application Ser. No. 09/853,366, filed May 11, 2001, and entitled “METHOD AND SYSTEM FOR THE OPTIMAL FORMATTING, REDUCTION AND COMPRESSION OF DEX/UCS DATA”.

### TECHNICAL FIELD

The present invention is related to the field of data acquisition and, more particularly, to a system and method for interpreting information communicated in disparate dialects.

### BACKGROUND OF THE INVENTION

Over the past decade, vending machine manufacturers have developed new and innovative vending equipment in response to market needs and vending operator demands. These innovations have been, for the most part, adopted by the food and beverage vending industry. This trend has been influenced by the accelerating rate of technological innovation in the electronic and electro-mechanical component industry. The availability of new technologies has given vending machine manufacturers the tools to address many of the requirements of vending operators. Advances in electronics are now enabling the use of computer controls and data acquisition systems directly inside the vending machine. Some of the latest developments now make it possible for vending machine operators to obtain in digital format machine information or as audit reports of sales, inventory, cash collection, product movement, and machine health information. The machine information or audit reports may be downloaded on-site onto portable computers or transmitted to a data acquisition system located within a central operations location.

These developments have made it easier for vending operators to gather and analyze data. However, vending operators often use a variety of computer systems and software programs resulting in a proliferation of different audit report formats. One data format used in audit reports in the United States is DEX/UCS (Direct Exchange of Uniform Communication Standards) or DEX, which is the National Automatic Merchandising Association (NAMA) standard for electronically retrievable audit data. One use of DEX is to establish standard data file formats that allow different types of vending machines and vending machine models to communicate electronically. However, as more vending operators adopt ways to communicate machine information, the associated software programs and audit reports have been modified to suit the wide variety of vending machines, computer systems, software programs. These modifications are sometimes referred to as dialects their own needs. For example, NAMA modified DEX from its original form and vending operators such as the Coca-Cola Company and PepsiCo, Inc. have further modified the DEX and frequently use more than one dialect for their audit reports. Because of the many modifications, audit reports with many different dialects currently communicate vending machine information. As a result, a data acquisition system at a central operations location will receive audit reports in many different dialects including dialects unknown to the data acquisition system. Current data acquisition systems do not automatically acquire or process data from the audit reports with unknown dialects. The acquisition and processing of data with unknown dialects generally requires a manual intervention. Without the manual intervention, the audit report with an unknown dialect is typically ignored by the data acquisition system or forced into a category with the closest similar dialect.

Because unknown dialects generally do not match existing dialects at the data acquisition system, audit reports with unknown dialects are often put into categories and analyzed with audit reports having similar but not the same dialects. Analyzing audit reports with unknown dialects within these categories results in corrupted data because audit reports with unknown dialects are not analyzed using the correct parameters and therefore returns faulty results. In addition, unknown dialects corrupt the analysis and results from other audit reports within the category that have a dialect similar to but not the same as the unknown dialect because the data acquisition system tries to make the data fit all together when it does not belong together.

### SUMMARY OF THE INVENTION

Therefore a need has arisen for a system and method which allows a data acquisition system to automatically acquire unknown dialects of audit reports. A further need has arisen for a system and method that handles audit reports with unknown dialects without corrupting the data within the audit report and resulting analysis of the data.

In accordance with the present invention, a system and method for interpreting information communicated in disparate dialects is provided which substantially eliminates or reduces disadvantages and problems associated with previously developed systems and methods for interpreting information communicated in disparate dialects. The system and method receives audit reports having data in multiple dialects including unknown dialects, interprets and validates data within the audit reports, and automatically acquires unknown dialects through the creation of new interpretation modules and new validation modules.

More specifically, a general parser accepts audit reports having disparate dialects. If the dialect of the audit report is known, a plurality of interpretation modules interpret the audit report by extracting the data from the audit report resulting in an interpretation result. A plurality of validation modules validate or analyze the audit reports and the interpretation results by performing validation tests which ask a series of finite pass/fail questions of the audit report and interpretation results.

In one embodiment, the general parser may receive audit reports having dialects that are unknown to the interpretation modules. When the dialect is unknown, the general parser does not force the audit report into an interpretation module that is not an exact match but instead marks or flags the audit report as having an unknown dialect. The marked audit report may be stored in a interpretation error table so that it can be accessed and addressed by an administrator at a later time.

In another embodiment, the general parser receives an audit report having a dialect that is unknown to the interpretation modules. Instead of marking the audit report as having an unknown dialect, a learning module associated with the general parser acquires the unknown dialect. The learning module may create both a provisional interpretation module using data from the unknown dialect audit report and a provisional validation module by determining which validation tests the unknown dialect audit report passes and fails. The learning module tests the provisional interpretation module and provisional validation module by comparing the interpretation and validation results of the unknown dialect audit report with the interpretation and validation results of additional audit reports having the same unknown dialect as the audit report used to create the provisional interpretation module and provisional validation module. If successfully tested, the provisional interpretation module and provisional validation module may be added to the associated data acquisition system as known interpretation modules and known validation modules, and the unknown dialect is now a known dialect.

The present invention provides a number of technical advantages. One technical advantage is automated acquisition of unknown dialects of audit reports. Not requiring manual intervention to acquire unknown dialects saves time, money, and manpower because the associated data acquisition system does not have to be constantly revised by an administrator because of unknown dialects.

Another important technical advantage of the present invention is the ability to process audit reports having multiple dialects including unknown dialects without corrupting the data from audit reports with known dialects. Because unknown dialects are automatically acquired, there is no need to force audit reports into categories that are not an exact match. The audit reports are grouped together in categories with other audit reports having the same dialect. Analysis of the data in the audit reports takes into account the analysis of past audit reports. Therefore, significantly less corruption of data occurs because analysis of past audit reports will generally agree with the analysis of current audit reports because the reports since data from the reports is analyzed using the appropriate dialect. There is no non-matched dialect to corrupt the results.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 illustrates a block diagram of a system for interpreting audit reports having data in multiple dialects;

FIG. 2 depicts a block diagram for an automated system for dialect acquisition of multiple dialects;

FIG. 3 illustrates a flow diagram of a method for interpreting audit reports communicated in multiple dialects;

FIG. 4 depicts a flow diagram of a method for the automated acquisition of multiple dialects;

FIG. 5 illustrates a block diagram of a system for communicating between a remote device and a network operations center that employs automated dialect acquisition of the present invention; and

FIG. 6 depicts a block diagram of one embodiment of a remote data acquisition system for vending machines that employs automated dialect acquisition of the present invention.

### DETAILED DESCRIPTION OF THE INVENTION

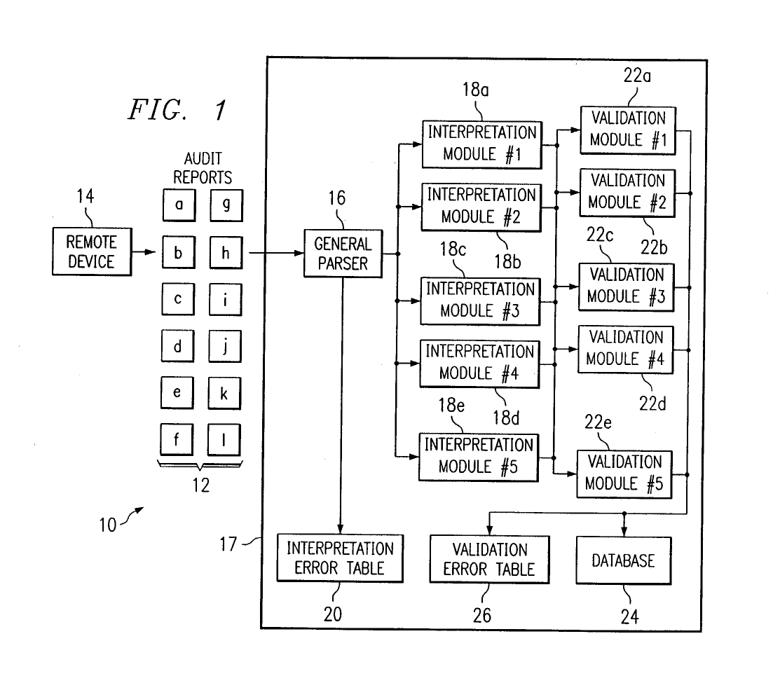

Preferred embodiments of the invention and its advantages are best understood by referring to FIGS. 1-6 of the drawings, like numerals being used for like and corresponding parts of the various drawings.

FIG. 1 depicts a block diagram of interpretation system 10 for interpreting and handling audit reports 12 having multiple dialects. Audit reports 12 may include DEX records, machine control records, machine audit records, or any other format data file.

In the embodiment shown in FIG. 1, remote device 14 transmits audit reports 12 to general parser 16. In other embodiments, there can be more than one remote device 14 transmitting audit reports 12 to general parser 16. Remote device 14 is a device capable of transmitting data regarding its operation such as a vending machine. For instance, remote device 14 can be a soda vending machine where audit reports 12 contain data such as the number of sales of soda, current inventory of soda within the vending machine, SKU numbers for the different types of sodas, and how many columns there are in the soda vending machine.

The dialect of audit report 12 determines how the data is arranged within audit report 12 transmitted to general parser 16. For example, audit report 12a is in dialect A and audit report 12b is in dialect B. Audit reports 12a and 12b contain the same data fields—specifically, record type, product type, price, SKU number, and number of columns. Dialect A arranges the data within audit report 12a in the following order: SKU number, record type, number of columns, product type, and price. Dialect B arranges the data within audit report 12b in the following order: record type, product type, price, SKU number, and number of columns. Audit reports 12a and 12b contain the same data fields, but the different arrangement of the data fields within audit reports 12a and 12b requires different analysis of audit reports 12a and 12b in order to extract and correctly interpret data from each audit report 12a and 12b.

In addition to the dialect determining how the data is arranged in audit reports 12, the dialect determines which data fields are included in audit reports 12. For instance, audit report 12c having dialect C may include the data fields of record type, product type, price, SKU number and number of columns while audit report 12d with dialect D may include the data fields of product type and price. The fact that audit reports 12c and 12d contain different amounts of data requires different analysis to correctly extract and interpret audit reports 12c and 12d.

General parser 16 may be located within network operations center (NOC) 17. NOC 17 communicates with remote device 14 across a wide area network and stores the data from audit reports 12. The operation of NOC 17 is described in greater detail in U.S. patent application Ser. No. 09/267,254, entitled “Remote Data Acquisition and Transmission System and Method ” filed Mar. 12, 1999.

After general parser 16 receives audit report 12, general parser 16 identifies which interpretation module 18 audit report 12 belongs in. In the embodiment shown in FIG. 1, there are five interpretation modules 18a, 18b, 18c, 18d, and 18e. In alternative embodiments, there can be more than five or less than five interpretation modules 18. Because each interpretation module 18 is specific to one dialect, general parser 16 determines which interpretation module 18 audit report 12 belongs in by examining the dialect of audit report 12.

Interpretation modules 18 interface with general parser 16 may also be located within NOC 17. Interpretation modules 18 extract the data from audit reports 12 by asking questions of audit reports 12. Interpretation modules 18 ask common questions that the owner or operator of remote device 14 is interested in knowing the answers. For example, if audit report 12 conveys data from a vending machine, then the common questions asked of audit reports 12 by interpretation module 18 may include how many selections there are within each vending machine, how many columns there are in the vending machine, and what product one selects by pushing a particular button on the vending machine. The common questions and answers, or interpretation results, are specific to each dialect and allow interpretation modules 18 to provide a common interface for data from audit reports 12 for each dialect.

In some instances general parser 16 cannot match an audit report 12 with any interpretation module 18. For example, assume that general parser 16 cannot match audit report 12e with any interpretation modules 18. In ability to match is often due to each interpretation module 18 being dialect specific and audit report 12e having a dialect unknown to any of interpretation modules 18. When the dialect is unknown to interpretation modules 18, general parser 16 marks or flags audit report 12e instead of forcing audit report 12e into an interpretation module 18 corresponding with a dialect similar to the dialect of audit report 12e, here interpretation module 18e. By not forcing audit report 12e into interpretation module 18e, data from other audit reports 12 that are correctly interpreted by interpretation module 18e will not be corrupted by the data from audit report 12e with an unknown dialect. After general parser 16 marks audit report 12e, NOC 17 stores audit report 12e in an interpretation error table 20 so that an administrator can address the unknown dialect at a later time.

Associated with general parser 16 and located in NOC 17, validation modules 22 validate and analyze data and interpretation results for audit reports 12. As with interpretation modules 18, each validation module 22 is specific to a respective dialect and general parser 16 identifies a validation module 22 for audit reports 12 by examining the dialects of audit reports 12. In the embodiment shown in FIG. 1, there are five validation modules 22a, 22b, 22c, 22d, and 22e but in alternative embodiments, NOC 17 can have more than five or less than five validation modules 22. NOC 17 will often have as many interpretation modules 18 and validation modules 22 as it has known dialects since each interpretation module 18 and validation module 22 is specific for each dialect.

Validation modules 22 analyze and test the data and interpretation results from audit reports 12 by performing a plurality of validation tests. The validation tests may include a finite series of forty pass/fail questions that validation module 22 asks of audit reports 12. Validation modules 22 compare the answers to the pass/fail questions or the validation results with past validation results of audit reports with the same dialect. The comparison allows validation modules 22 to determines if the data from audit report 12 has been corrupted by checking that the validation results returned by audit reports 12 agrees with known information about remote device 14. The known information stored in database 24 within NOC 17 as data and validation results from previously validated audit reports. Validation modules 22 detect and check if the data and validation results from audit reports 12 agree with the data and validation results stored in database 24. More specifically, validation modules 22 may check numerous items including: if a controller for remote device 14 has been moved to a different remote device; data corruption within audit reports 12; audit reports 12 not following proper dialect standards; and mapping for vending machines which checks that the selection buttons on the vending machine are properly mapped to the indicated goods.

For instance, validation modules 22 analyze and validate audit reports 12f and 12g. Audit report 12f passes validation, NOC 17 updates database 24 by adding the data from audit report 12f as well as the validation results. Audit report 12g fails validation and NOC 17 stores the data from audit report 12g as well as the reasons for failure in validation error table 26. An administrator can then address audit report 12g and the reasons for failing validation at a later time. Upon examination of audit report 12g and the reasons for failing validation, the administrator may discover that the data in audit report 12g is not really corrupted but instead that the vendor swapped the controllers between two vending machines and therefore system 10 will need to be reconfigured to account for the swapped controllers.

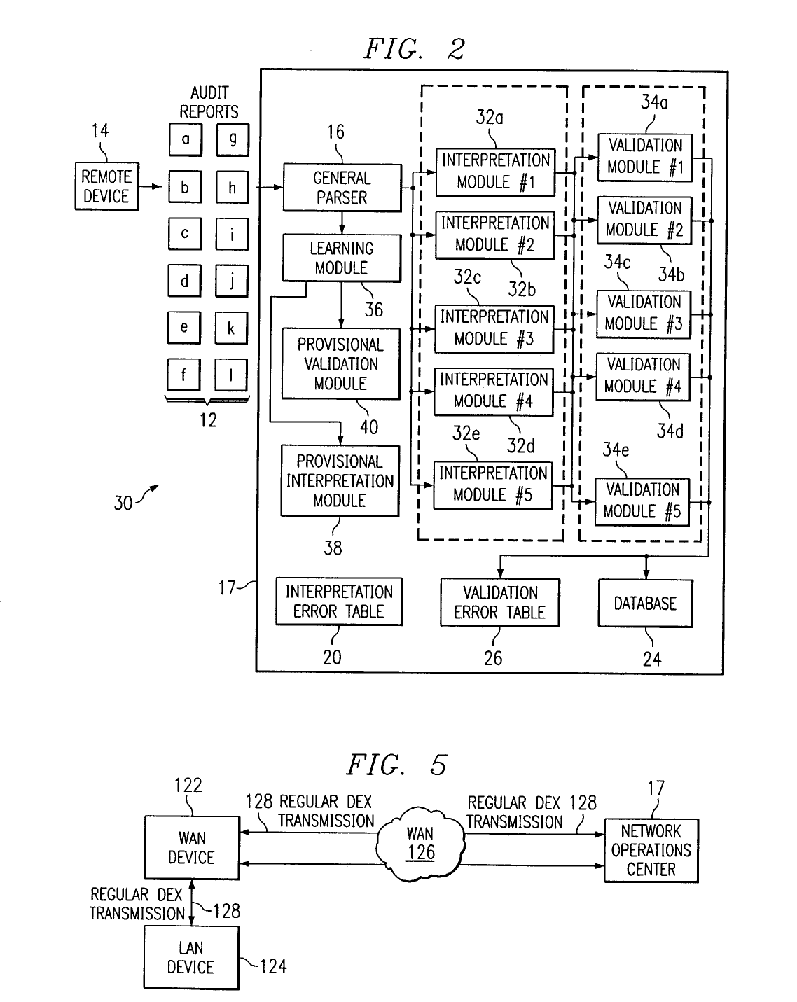

FIG. 2 depicts a block diagram for data acquisition system 30 for automatically acquiring unknown dialects from audit reports 12. For audit reports 12 having dialects known to NOC 17, system 30 functions in the same way as system 10. System 30 functions differently than system 10 when system 30 encounters audit reports 12 having dialects unknown to NOC 17.

Known interpretation modules 32 and known validation modules 34, associated with general parser 16, operate in the same manner as interpretation modules 18 and validation modules 22 in FIG. 1 with respect to known dialects. As with FIG. 1, the embodiment shown in FIG. 2 has five known interpretation modules 32 and five known validation modules 34 whereas alternative embodiments can have more than five or less than five known interpretation modules 32 and known validation modules 34.

In system 30, general parser 16 receives audit report 12h having a dialect unknown to NOC 17. General parser 16 attempts to place audit report 12h into one of known interpretation modules 32. Because known interpretation modules 32 are dialect specific and audit report 12h has a dialect unknown to NOC 17 and known interpretation modules 32, general parser 16 cannot place audit report 12h into any of known interpretation modules 32 since there is no matching dialect and general parser 16 does not force audit reports 12 into known interpretation modules 32 having a similar but not the same dialect.

When general parser 16 determines that audit report 12h does not belong in any known interpretation modules 32, general parser 16 invokes learning module 36, which is associated with general parser 16 and NOC 17. General parser 16 transfers audit report 12h to learning module 36. Learning module receives audit report 12h and examines the data in audit report 12h. By extracting and examining the data in audit report 12h, learning module 36 determines what an appropriate interpretation module would be for the unknown dialect and thereby creates provisional interpretation module 38. Once created, provisional interpretation module 38 extracts the data from audit report 12h and interprets audit report 12h. Learning module 36 then associates provisional interpretation module 38 with general parser 16 so that general parser can use provisional interpretation module 38 in the same manner that it uses known interpretation modules 32. Provisional interpretation module 38 has the same functionality as known interpretation modules 32 in that it extracts data from audit reports 12 and interprets the data.

When general parser 16 uses provisional interpretation module 38 as a known interpretation module, general parser 16 assigns the dialect of audit report 12h to provisional interpretation module 38. Therefore, when general parser 16 receives audit report 12i appearing to have the same dialect as audit report 12h, general parser 16 places audit report 12i in provisional interpretation module 38. Provisional interpretation module 38 extracts data from audit report 12i and then interprets the data just like known interpretation modules 32.

When provisional interpretation module 38 has interpreted more than one audit report 12, learning module 36 begins to test provisional interpretation module 38 to determine if provisional interpretation module 38 is the correct interpretation module for the unknown dialect. Learning module 36 tests provisional interpretation module 38 by comparing the interpretation results of audit report 12h, the audit report used to create provisional interpretation module 38, with the interpretation results of audit report 12i, the audit report appearing to have the same dialect as the audit report used to create provisional interpretation module.

In testing provisional interpretation module 38, learning module 36 checks for two things. First learning module 36 checks if the interpretation of audit reports 12h and 12i returns semantically reasonable values to the common questions asked by provisional interpretation module 38. Semantically reasonable values are interpretation results that make since for the type of remote device 14 that audit reports 12h and 12i come from. For instance, if audit reports 12h and 12i are from a vending machine, the common questions asked by provisional interpretation module may include how many selections there are within the vending machine and how many columns there are in the vending machine. So if the interpretation results for the common question of how many columns there are within the vending machine returns a value of 1,000, this is not a semantically reasonable value because a typical vending machine does not have 1,000 columns. Therefore, provisional interpretation module 38 created for the dialect of 12h and 12i would not be correct. But if the interpretation results returned that the vending machine has eight columns, then that is a semantically reasonable value and provisional interpretation module 38 may be correct and requires more testing to assume it is correct.

Second, learning module 36 tests provisional interpretation module 38 by comparing the interpretation results of audit reports 12h and 12i. For example, learning module 36 compares the interpretation results of audit report 12h to the interpretation results of audit report 12i for the question of how many columns there are in the vending machine. If both audit reports 12h and 12i return that there are eight columns, then that is evidence that provisional interpretation module 38 may be the correct interpretation module for the dialect of audit reports 12h and 12i. Learning module 36 compares the interpretation results for all audit reports 12 appearing to have the same dialect as audit report 12h to further test provisional interpretation module 38.

Once learning module 36 has successfully tested provisional interpretation module 38 for semantically reasonable values and compared the interpretation results with a sufficient number of audit reports 12, learning module 36 makes a determination that provisional interpretation module 38 is the correct interpretation module for the dialect of audit report 12h. Therefore, provisional interpretation module 38 loses its provisional status and becomes part of known interpretation modules 32 resulting in data acquisition system 30 acquiring a new dialect.

In addition to interpreting audit reports 12 having unknown dialects, system 30 must also validate audit reports 12 having unknown dialects. Therefore, after provisional interpretation module 38 interprets audit report 12h, it transfers audit report 12h along with the interpretation results back to learning module 36. Using the data and interpretation results for audit report 12h, learning module 36 creates provisional validation module 40 by performing all of the validation tests on the interpretation results.

The validation tests may include the same forty questions asked by validation modules 22 in FIG. 1. But with known dialects, known validation modules 34 do not generally ask all forty questions but only ask questions that apply to that particular dialect. Because the dialect of audit report 12h is unknown, learning module 36 assumes that audit report 12h will pass all forty questions and therefore asks all forty questions of the interpretation results of audit report 12h. Learning module 36 then determines which questions audit report 12h passes and which questions audit report 12h fails. To create provisional validation module 40, learning module 36 may turn on all the passed questions and turn off all the failed questions. Therefore, provisional validation module 40 only asks the questions that audit report 12h passed. Learning module 36 marks as tentative provisional validation module 40 and places it among known validation modules 34 so that when general parser 16 receives future instances of the dialect of audit report 12h, the interpretation results for the dialect are validated by provisional validation module 40 and a new provisional validation module will not need to be created for the same unknown dialect.

Learning module 36 tests provisional validation module 40 to determine if it correctly validates and analyzes additional audit reports 12 having the same dialect as audit report 12h. For instance, audit report 12i appears to have the same dialect as audit report 12h. The interpretation results for audit report 12i are sent to provisional validation module 40. Provisional validation module 40 performs validation tests of the turned on passed questions on the interpretation results for audit report 12i and determines if audit report 12i passes validation. If audit report 12i passes validation, learning module 36 notes that two audit reports have now passed validation for provisional validation module 40 and that provisional validation module 40 may be the correct validation module for the dialect of audit reports 12h and 12i.

Learning module 36 also notes if audit report 12i does not pass validation because this provides evidence that audit reports 12h and 12i are not of the same dialect or that provisional validation module 40 is not the correct validation for the dialect of audit reports 12h and 12i. Data acquisition system 30 may store audit report 12i and the reasons for failing validation in validation error table 26 at NOC 17 or other designated locations. Learning module 36 then has the option of creating a different provisional validation module for audit report 12i, creating a different provisional validation module for audit reports 12h and 12i combined, or doing nothing until provisional validation module 40 can test additional audit reports 12.

Learning module 36 continues to monitor provisional validation module 40 until provisional validation module 40 successfully validates a set number of audit reports 12 having the same dialect as audit report 12h. For instance, learning module 36 may require provisional validation module 40 to successfully validate fifty audit reports 12 before it is assumed to be correct. The number of audit reports required to be successfully passed depends on various factors such as how many data fields are within audit reports 12 and the precision desired by system 30. After successful validation, learning module 36 assumes provisional validation module 40 to be correct and therefore removes the provisional status and provisional validation module 40 becomes a known validation module 34.

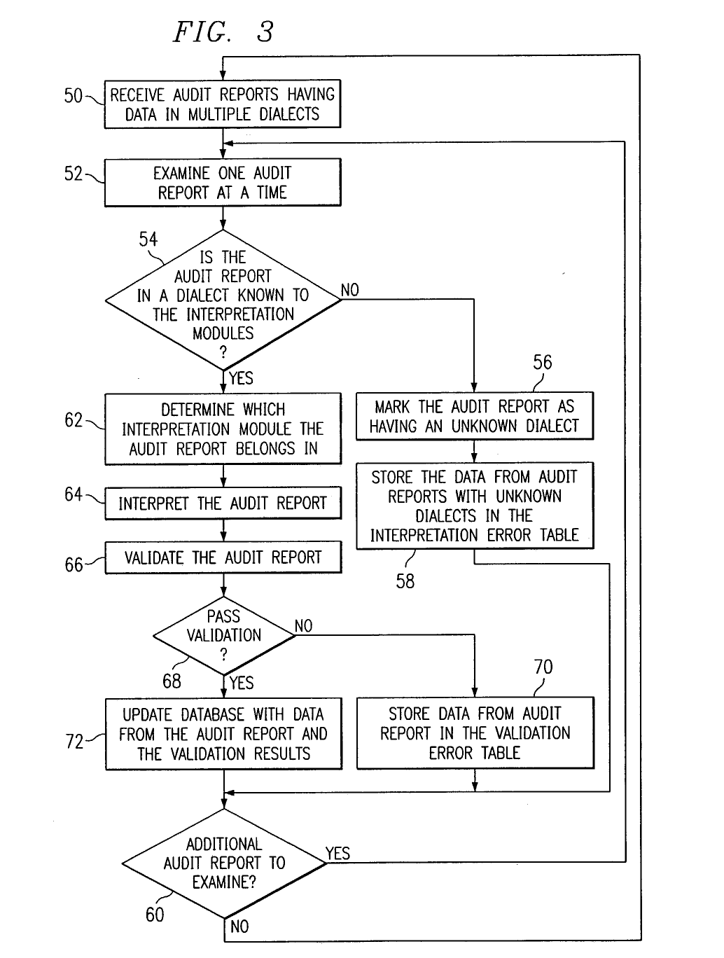

FIG. 3 illustrates a flow diagram of a method for interpreting and receiving audit reports 12 communicated in multiple dialects, both known and unknown. In step 50, general parser 16 receives a plurality of audit reports 12. Audit reports 12 have their own dialects which can be the same or different from the dialects of other audit reports 12. General parser 16 takes audit reports 12 and processes and examines them one audit report at a time in step 52.

In step 54, general parser 16 determines if audit report 12 is in a dialect that is known to interpretation modules 18. If audit report 12 is unknown to interpretation modules 18, then in step 56 general parser 16 marks audit report 12 as having a dialect unknown to interpretation modules 18. In step 58, data acquisition system 30 stores marked audit report 12 in interpretation error table 20. The process then continues to step 60 wherein general parser 16 determines if there are additional audit reports 12 to examine. If there are additional audit reports 12 to examine, then general parser 16 examines the next audit report in step 52. If there are no additional audit reports 12 to examine, then general parser 16 receives additional audit reports 12 in step 50.

If the dialect of audit report 12 is known to one of interpretation modules 18, then in step 62 general parser 16 determines which interpretation module 18 audit report 12 belongs in. Each interpretation module 18 is dialect specific and therefore only accepts audit reports 12 in one dialect. Once general parser 16 matches the dialect of audit report 12 with the correct dialect of interpretation module 18, interpretation module 18 interprets audit report in step 64. Interpreting audit report 12 comprises extracting the data from audit report 12 and asking common questions of audit report 12 to arrive at interpretation results that give information about remote device 14.

After interpretation module 18 interprets audit report 12, validation module 22 validates the interpretation results for audit report 12 in step 66. Validation requires performing a series of finite test questions on the interpretation results for audit report 12. Validation module 22 asks a series of pass/fail questions and returns validation results containing whether or not audit report 12 passed or failed each test question. If audit report 12 fails any of the pass/fail questions, then audit report fails validations in step 68. If audit report 12 does fails validation, then in step 70 data acquisition system 30 stores audit report 12, interpretation results, and reasons for failure in validation error table 26. But if audit report 12 passes validation in step 68, then in step 72 NOC 17 updates database 24 with the data from audit report 12 and the validation results. Regardless of whether audit report 12 passes or fails validation, after updating database 24 or storing audit report 12 in validation error table 26, the process continues to step 60 where general parser 16 determines if there are additional audit reports to examine and then the process repeats to examine additional audit reports.

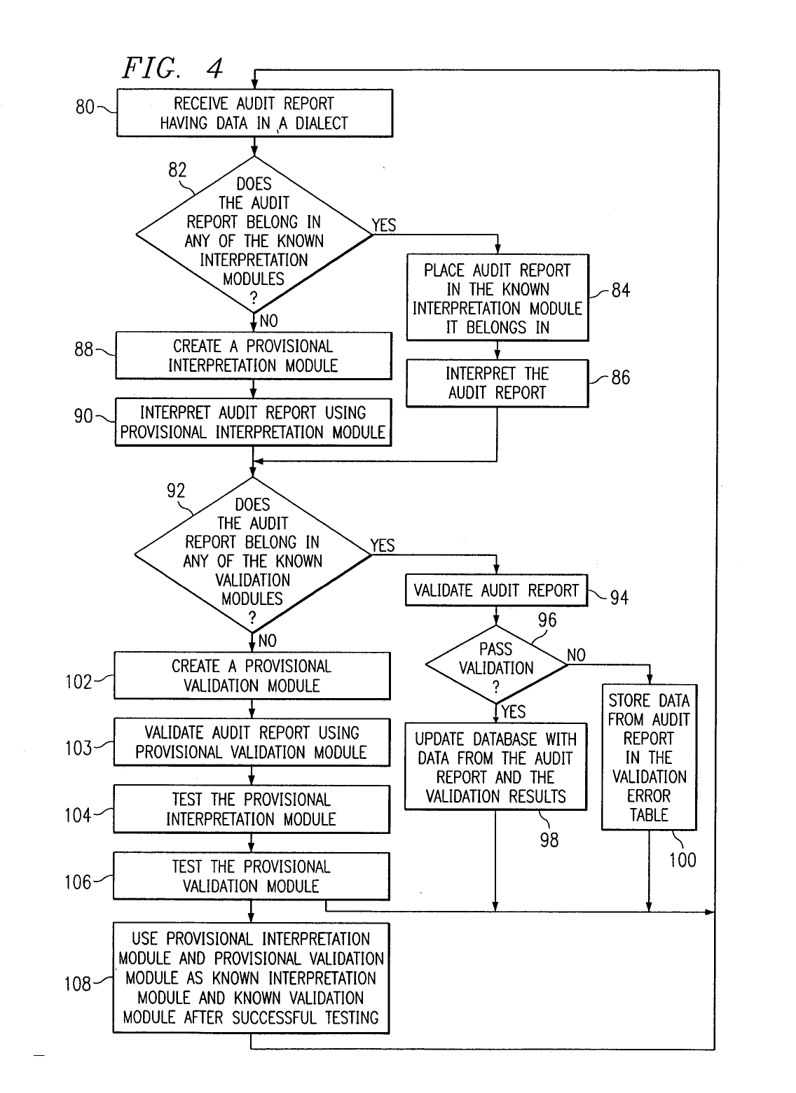

FIG. 4 depicts a flow diagram of a method for the automated acquisition of unknown dialects from audit reports 12. In step 80, general parser 16 receives audit report 12 having data in a dialect. In step 82, General parser 16 determines if audit report 12 contains a dialect corresponding with any known dialects of interpretation modules 32 by examining audit report 12 including the dialect of audit report 12. Because known interpretation modules 32 are dialect specific, general parser 16 attempts to match the dialect of audit report 12 with one of the dialects of known interpretation modules 32. If the dialect of audit report 12 does not belong in any of known interpretation modules 32, then general parser 16 determines that the dialect of audit report 12 is an unknown dialect. In step 82, if general parser 16 determines that audit report 12 does belong in a known interpretation module 32, then in step 84 general parser 16 places audit report 12 in the known interpretation module 32 to which it belongs. In step 86, known interpretation module 32 interprets audit report as described above in step 64 of FIG. 3.

When audit report 12 does not belong to any of known interpretation modules 32 in step 82, then in step 88 learning module 36 creates provisional interpretation module 38. Learning module 36 uses the data from audit report 12 to create provisional interpretation module 38. Learning module 36 examines the data from audit report 12 for an understanding of the dialect of audit report 12 and then guesses at what an appropriate interpretation module looks like for the dialect of audit report 12. In step 90, provisional interpretation module 38 interprets audit report 12 by extracting the data from audit report 12, asking common questions, and getting interpretation results.

After either provisional interpretation module 38 or known interpretation module 32 interprets audit report 12, in step 92 general parser 16 determines if audit report belongs in any of known validation modules 34. As with interpretation modules, validation modules are dialect specific so that the dialect of audit report 12 must match the dialect of a known validation module 34. If audit report 12 does belong in one of known validation modules 34, then in step 94 known validation module 34 validates audit report 12 as described in step 66 of FIG. 3. Known validation module 34 determines if audit report 12 passes validation in step 96 and either updates database 24 with the data from audit report 12 and validation results in step 98 if audit report passes validation or stores audit report 12 and the reasons for failure in validation error table 26 in step 100 if audit report 12 fails validation. The process then repeats beginning with general parser 16 receiving an audit report having a dialect in step 80.

When audit report 12 does not belong to any of the known validation modules 34, in step 102 learning module 36 creates provisional validation module 40. Learning module 36 creates provisional validation module 40 by performing validation tests on audit report 12. The validation tests are forty questions that return either a pass or fail answer and are asked of audit report 12 and its interpretation results. To make provisional validation module 40 as strict as possible, learning module 36 assumes that audit report 12 will pass validation and therefore asks all forty questions. Learning module 36 monitors which questions audit report 12 passes and fails and consequently turns on the questions passed and turns off the questions failed. Therefore, provisional validation module 40 consists of only the validation test questions that audit report 12 passes. After learning module 36 creates provisional validation module 40, provisional validation module 40 analyzes or validates audit report 12 in step 103.

Learning module tests provisional interpretation module 38 in step 104 and tests provisional validation module 40 in step 106. Testing ensures that provisional interpretation module 38 and provisional validation module 40 are correct for the dialect of audit report 12 from which they were created. Learning module 36 tests provisional interpretation module 38 by using it to interpret additional audit reports 12 that appear to have the same dialect as audit report 12 used to create provisional interpretation module 38. The interpretation results for each audit report 12 interpreted by provisional interpretation module 38 are compared against each other to determine if the interpretation results are semantically reasonable as explained above.

Testing provisional validation module 40 in step 106 involves using provisional validation module 40 to test and analyze additional audit reports 12 that appear to have the same dialect as audit report 12 used to create provisional validation module 40. Learning module 36 compares the validation results to ensure that audit reports having the same dialect pass validation performed by provisional validation module 40. After testing provisional interpretation module 38 and provisional validation module 40, the process returns to step 80 where general parser 16 receives an audit report having a dialect.

While the process in steps 80 through 106 repeats, learning module 36 monitors provisional interpretation module 38 and provisional validation module 40. The provisional modules retain their provisional status but are used along side known interpretation modules 32 and known validation modules 34. This allows for the testing of provisional interpretation module 38 and provisional validation module 40 and allows data acquisition system 30 to accept, handle, and process audit reports 12 having unknown dialects. In step 108, once provisional interpretation module 38 and provisional validation module 40 have correctly interpreted and validated a set number of audit reports 12, learning module 36 assumes provisional interpretation module 38 and provisional validation module 40 to be correct, removes their provisional status, and makes them known interpretation modules and known validation modules.

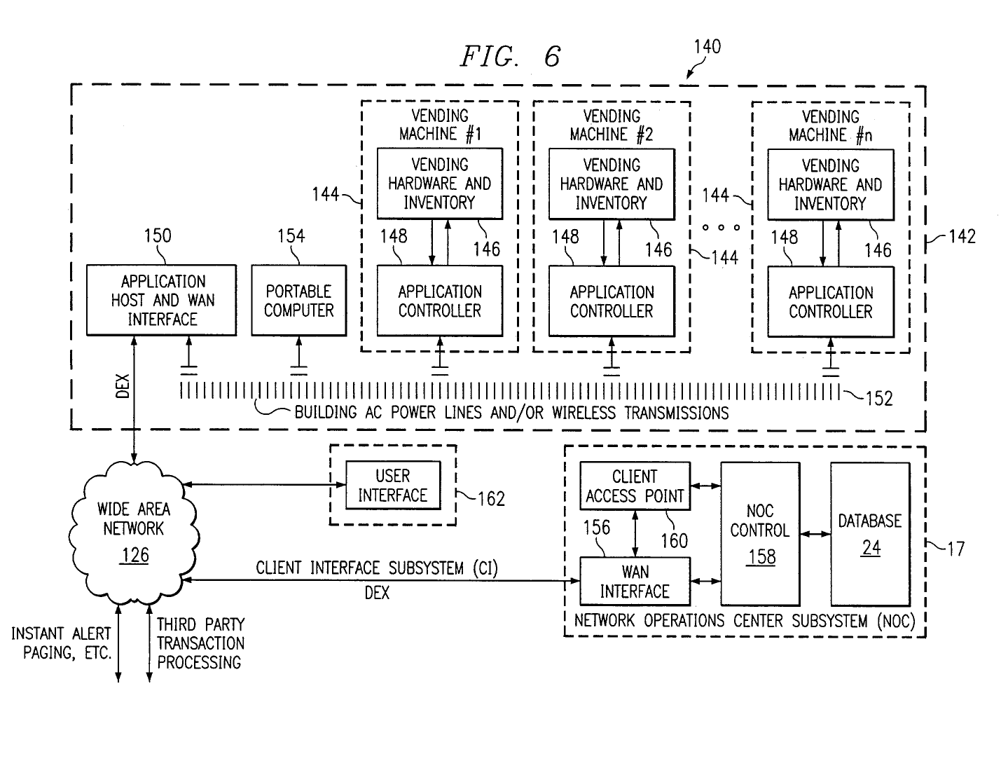

FIG. 5 illustrates a block diagram of a system for communicating between remote device 14 and NOC 17 incorporating automatic dialect acquisition of the present invention. System 120 of FIG. 5 preferably includes NOC 17 communicatively coupled to wide area network (WAN) device 122 and local area network (LAN) device 124 via wide area network 126. Wide area network 124 can be either a wireless or a wire-line network. Wireless networks include electromagnetic communications over wires, cables, or other types of conduits while wire-line networks include all types of electromagnetic communications which do not require a wire, cable, or other types of conduits.

System 120 utilizes a communication scheme for communicating between the NOC 17 and WAN device 122 and/or LAN device 124. The communication scheme may include DEX/UCS protocol of data transfer as indicated at 128. Information in the DEX/UCS record or audit report 12 relates to various states of the remote device and may include information such as inventory levels, number of vends, condition of device hardware, as well as any other characteristic capable of being monitored and contained in DEX/UCS data blocks.

FIG. 6 depicts a functional block diagram of one embodiment of remote data acquisition system 140 for obtaining information from remote devices such as vending machines and where system 140 employs automated dialect acquisition of the present invention. In general, system 140 of FIG. 6 communicates information from vending site 142 externally over a wide area wireless or wire-line network and internally over a local area wireless or wire-line network. As shown, the local area network at vending site 142 can be referred to as a device interrogation LAN subsystem (DIL). Vending site 142 may include only one vending machine 144 or a plurality of vending machines 144. Each vending machine 144 may include vending hardware (not expressly illustrated) and inventory 146 for performing vending functions and electronically tracking some vending information. Vending machines 144 may provide various types of products to customers such as soft drinks, snacks, etc.

Each vending machine 144 may include an application controller 148 coupled to and interfacing with vending hardware and inventory 146. Many vending machines 144 are equipped with electronics for controlling vending operations as well as tracking some vending events such as money received, change given and number of vends from each slot. Application controllers 148 can communicate with such embedded electronics as well as be equipped to directly sense other vending events and vending equipment parameters (e.g. compressor performance). Application controllers 148 can also communicate with one another and the application host 150 via onboard transceivers using wire-line or wireless transmissions. Either the application controller 148 or the application host 150 can be configured to process audit reports 12 in the DEX/UCS format.

Together, application controllers 148 and application host 150 form a LAN supported by the wire-line and/or wireless transmissions 152. In addition, application controllers 148 can also act as repeaters in case application host 150 cannot directly communicate with a particular application controller 148 while another application controller 148, which does have an established communication link with application host 150, can directly communicate.

Application host 150 acquires data captured by application controllers 148 and packages and communicates that data across an external network 126 using a wide area network (WAN) interface. Application host 150 can be installed together with application controller 148 inside a vending machine or housed separately in another location. In the event that the application host 150 is placed inside a vending machine together with an application controller 148, it is possible to share some of the electronic components between them, the LAN transceiver for example, in order to reduce the cost of the hardware. In this case, the application host 150 and application controller 148 inside the same vending machine, would preferably communicate with each other over a hardwired interface between the two components. Alternatively, the application host 150 and application controller 148 can be designed to be a single integrated component within a vending machine. Furthermore, an application host 150 can be used whose function preferably consists of monitoring the application controllers 148. For example, such an application host 150 could take the form of a hand-held portable computer 154 to be carried by service or delivery personnel in order to query the application controllers 148 without having to interact via the WAN interface 156. In one embodiment, application host 150 and/or application controller 148 may be used to perform the preferred functions associated with the automated or “Call-In” mode of operation mentioned above.

The WAN interface 156 can be implemented in a number of ways. In particular, WAN interface 156 is designed to support a wide area network 126 that can be implemented via wire-line or wireless transmissions. If a wireless narrowband PCS paging network is used to implement the WAN, messages from application host 150 can be communicated as digital messages through the paging network, stored and delivered by the network carrier to NOC 17 using, for example, a secure Internet connection.

As shown in FIG. 6, NOC 17 communicates with one or more vending sites 142 across wide area network 126. As mentioned, in one implementation, NOC 17 can access information transmitted by application hosts 150 at vending sites 142 using the network carrier's infrastructure. In the embodiment of FIG. 6, NOC 17 includes a NOC control 158 that communicates with wide area network 126 through a WAN interface 156. NOC control 158 can receive data in audit reports 12 acquired from and transmit data to vending sites 142, interpret and validate audit reports 12, and store audit reports 12 and validation results in database 24. NOC control 158 can also perform instant alert paging, direct dial alarms and other functions to provide real time notification to a vending operator upon the occurrence of certain events (e.g., out-of-stock, power outage, vandalism, etc.). NOC control 158 can also provide third party transaction processing such as allowing queries on database 24. The WAN interface 156 between NOC control 158 and the wide area network 126 can be implemented through the use of either wire-line or wireless transmissions.

At NOC 17, a client access point 160 provides access from a client interface subsystem (CI) 162 across external network 164. In one implementation, client access point 160 can be a web-based interface allowing user access from a client computer across a network such as the Internet. Other implementations include providing a direct-dial connection between client interface subsystem 162 and client access point 160. Once connected, a user can use client interface subsystem 162 to obtain information from database 24 based upon data acquired from vending sites 142. Further, users can be provided with extended services such as trend information developed by mining and analyzing database 24.

Although the present invention has been described with respect to a specific preferred embodiment thereof, various changes and modifications may be suggested to one skilled in the art and it is intended that the present invention encompass such changes and modifications fall within the scope of the appended claims.

What is claimed is:

1. A method for interpreting information communicated in multiple dialects, the method comprising:
receiving a plurality of audit reports having data in multiple dialects;
marking each audit report having a dialect unknown to a plurality of interpretation modules;
interpreting the plurality of audit reports using the plurality of interpretation modules for respective known dialects; and
validating the plurality of audit reports having a known dialect.

2. The method of claim 1 further comprising storing data from the audit reports having the unknown dialect in an interpretation error table.

3. The method of claim 1 wherein receiving the audit reports comprises determining which interpretation module has a dialect corresponding with the dialect of the audit reports.

4. The method of claim 1 further comprising storing the data from the audit reports in a database.

5. The method of claim 1 wherein validating the audit reports comprises performing a plurality of validation tests on the audit reports.

6. The method of claim 1 wherein validating the audit reports comprises updating the database with data from the audit report and a plurality of validation results when the audit report passes the validation tests.

7. The method of claim 1 wherein validating the audit report comprises storing the data in the audit reports in a validation error table associated when the audit report fails the validation tests.

8. A method for automated dialect acquisition of disparate dialects, the method comprising:
receiving an audit report having data in an unknown dialect;
determining that the audit report does not belong in any one of a plurality of known interpretation modules corresponding with respective known dialects;
creating a provisional interpretation module;
determining that the audit report does not belong in any one of a plurality of known validation modules;
creating a provisional validation module;
testing the provisional interpretation module; and
testing the provisional validation module.

9. The method of claim 8 wherein determining that the audit report does not belong in any one of a plurality of known interpretation modules comprises examining the audit report to attempt to identify the unknown dialect.

10. The method of claim 8 wherein determining that the audit report does not belong in any one of a plurality of known interpretation modules comprises attempting to match the audit report with respective known dialects of the known interpretation modules.

11. The method of claim 8 wherein creating a provisional interpretation module comprises;
examining the audit report; and
deciding the form for the provisional interpretation module.

12. The method of claim 8 wherein determining that the audit report does not belong in any one of a plurality of known validation modules comprises testing the audit report against the respective known dialects of the known validation modules.

13. The method of claim 8 wherein creating a provisional validation module comprises performing a series of validation tests on the audit report.

14. The method of claim 13 wherein the series of validation tests comprise a finite number of tests returning pass or fail answers.

15. The method of claim 13 wherein creating the provisional validation module comprises determining which validation tests the audit report passes and which validation tests the audit report fails.

16. The method of claim 15 wherein creating the provisional validation module comprises:
turning off all the tests the audit report fails; and
turning on all the tests the audit reports passes.

17. The method of claim 8 wherein testing the provisional interpretation module comprises determining if the provisional interpretation module returns semantically reasonable values.

18. The method of claim 8 wherein testing the provisional validation module comprises using the provisional validation module to analyze additional audit reports with dialects the same as the dialect of the audit report used to create the provisional validation module.

19. A system for interpreting information communicated in multiple dialects which are known and unknown by the system, the system comprising:
a plurality of audit reports in multiple dialects;
a general parser operable to receive the audit reports and mark the audit reports having an unknown dialect;
a plurality of interpretation modules associated with the general parser, the interpretation modules operable to extract data from the audit reports with known dialects; and
a plurality of validation modules associated with the general parser, the validation modules operable to analyze the audit reports with known dialects.

20. The system of claim 19 wherein the audit reports comprise DEX records.

21. The system of claim 19 wherein the general parser identifies respective interpretation modules corresponding with the dialect of each audit report.

22. The system of claim 19 wherein the general parser identifies respective validation modules corresponding with the dialect of each audit report.

23. The system of claim 19 wherein each interpretation module corresponds to a respective dialect.

24. The system of claim 19 wherein each validation module corresponds to a respective dialect.

25. The system of claim 19 wherein the validation modules perform a plurality of validation tests on the audit reports.

26. The system of claim 25 wherein the validation tests comprise a finite number of tests asking pass and fail questions.

27. The system of claim 19 further comprising a network operations center associated with the general parser, interpretation modules, and validation modules, the network operations center including a database, a validation error table, and an interpretation error table, the network operations center operable to store within the database the data from the audit reports.

28. A system for automated dialect acquisition of disparate dialects, the system comprising:
an audit report having data in an unknown dialect;
a general parser associated with the audit report, the general parser operable to receive the audit report;
a plurality of known interpretation modules associated with the general parser, the known interpretation modules operable to extract data from the audit report;
a plurality of known validation modules associated with the general parser, the known validation module operable to analyze the audit report; and
a learning module associated with the general parser, the learning module operable to create a provisional interpretation module and a provisional validation module based upon the data in the audit report.

29. The system of claim 28 wherein the audit report comprises a DEX record.

30. The system of claim 28 wherein the general parser determines if the audit report belongs in any of the known interpretation modules.

31. The system of claim 28 wherein the general parser determines if the audit report belongs in any of the known validation modules.

32. The system of claim 28 wherein the general parser transfers to the provisional interpretation module additional audit reports with a dialect the same as the dialect of the audit report used to create the provisional interpretation module.

33. The system of claim 28 wherein the learning module creates the provisional interpretation module by examining the audit report and making a guess as to an interpretation module for the unknown dialect.

34. The system of claim 28 wherein the learning module creates the provisional validation module by performing a plurality of validation tests on the data in the audit report.

35. The system of claim 34 wherein the validation tests comprise a finite number of test questions returning pass or fail answers.

36. The system of claim 34 wherein the learning module assumes that the provisional validation module will pass all the validation tests and performs all the validation tests on the data from the audit report.

37. The system of claim 34 wherein the learning module determines which validation tests the audit reports passes and fails, turns off the validation tests the audit report fails, and turns on the validation tests the audit report passes.

38. The system of claim 28 wherein the learning module tests the provisional interpretation module to determine if the provisional interpretation module returns semantically reasonable values for audit reports having the same dialect.

39. The system of claim 28 wherein the provisional interpretation module remains provisional until the provisional interpretation module returns semantically reasonable values for audit reports having the same dialect.

40. The system of claim 28 wherein the provisional validation module remains provisional until the provisional validation module passes a set number of audit reports having the same dialect as the dialect of the audit report used to create the provisional validation module.
